(19) United States
(12) Patent Application Publication
(10) Pub. No.: US 2024/0160788 A1
(43) Pub. Date: May 16, 2024

(54) OPEN HIDDEN LIKES, OPEN HIDDEN FAVOURITES PROVIDES PRIVACY IN SOCIAL MEDIA

(71) Applicant: MALLIKARJUNARAO KODIDALA, HYDERABAD (IN)

(72) Inventor: MALLIKARJUNARAO KODIDALA, HYDERABAD (IN)

(21) Appl. No.: 18/282,599

(22) PCT Filed: Mar. 17, 2022
(86) PCT No.: PCT/IB2022/052424

§ 371 Date: Sep. 18, 2023

(30) Foreign Application Priority Data
Mar. 17, 2021 (IN) 202141011411

(51) Int. Cl. G06F 21/62; G06F 9/451; G06Q 50/00

(52) U.S. Cl. CPC G06F 21/629; G06F 9/451; G06Q 50/01

(57) ABSTRACT

A computer implemented system configured to operate user-generated features of content on a social media platform, wherein the system comprises of a web server to access data like personal details, posts, likes, favourites, followers and following. A database to store all the data containing in the platform. The network interface configured to receive a network communication sent by a generating user of the broadcast comprising an indication that the user-generated features of content has been uploaded. A processor coupled to the network interface and configured to open and/or hidden like, and open and/or hidden favorites buttons to be displayed along with the user-generated content to others to choose. The system securely operates the features open or the hidden like, and the open or the hidden favourite.

### BACKGROUND OF THE INVENTION

People like to interact with content. Social media provides an easy and convenient way to stay in touch with friends when time doesn't allow you to meet with them in person. We oftentimes share content that we see as benefiting a friend or a group of friends or that has relevance to a relationship. People share, like, retweet or favourite may not represent their true self but their ideal self. People constantly pursue behaviors that bring them closer to their ideal self. Therefore, the content that they share may very well represent the person that they want the world to see and not the person that they truly are.

By liking, sharing or favoriting each other's posts, we maintain and add value to our relationships. There is also a reciprocity effect involved, in the sense that we feel we should give something back to people who have given to us.

While social media makes it easier to meet new people and make friends, it also enables cruel people to tear into others with little effort. Perpetrators of bullying can use the anonymity that social networks provide to gain people's trust and then terrorize them in front of their peers. For instance, they might create a fake profile and act friendly to a classmate, then later betray and embarrass them online.

Unfortunately, there's no clear-cut way to hide your posts from other people, either followers or non-followers.

The only options available are workarounds that pose some other limitations to your account, and you should perform them only if you're desperate to remove or hide your likes.

Hence, inventor felt a dire need for a system that can be operated on user-generated features of content on a social media platform, providing options of open and hidden likes, and open and hidden favorite options to display along with the user-generated content.

### BRIEF SUMMARY OF THE INVENTION

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

It is an object of the invention to implement the system and method configured to operate user-generated features of content on a social media platform.

It is another object of the invention to provide options of open and hidden likes, and open and hidden favorite options to display along with the user-generated content.

According to an aspect of the present invention, a computer implemented system configured to operate along with user-generated content on a social media platform is disclosed.

In accordance with an aspect of the present invention, the system comprises of a web server, a database, a network interface and a processor. The web server to access data like personal details, posts, likes, favorites, followers and following. The database stores all the data containing in the platform.

In accordance with an aspect of the present invention, the said network interface configured to receive a network communication sent by a generating user of the broadcast comprising an indication that the user-generated features of content have been uploaded.

In accordance with an aspect of the present invention, the system comprises rules engine coupled with the network interface and the processor.

In accordance with an aspect of the present invention, the system divides the gallery into the open gallery and hidden gallery.

Further objects, features, and advantages of the invention will be readily apparent from the following description of the preferred embodiments thereof, taken in conjunction with the accompanying drawings.

### BRIEF DESCRIPTION OF THE DRAWINGS

The invention will be further understood from the following detailed description of a preferred embodiment taken in conjunction with an appended drawing, in which:

FIG. 1 illustrates the images depicting open and hidden like buttons, according to the exemplary embodiment of the present invention;

FIG. 2 illustrates the images depicting the open and hidden favorite buttons, according to the exemplary embodiment of the present invention;

FIG. 3 illustrates the image depicting the liking options of the user picture, according to the exemplary embodiment of the present invention;

FIG. 4 illustrates the image depicting the open like of the user picture, according to the exemplary embodiment of the present invention;

FIG. 5 illustrates the image depicting the hidden like of the user picture, according to the exemplary embodiment of the present invention;

FIG. 6 illustrates the image depicting the open liked users list and users count, according to the exemplary embodiment of the present invention;

FIG. 7 illustrates the image depicting the hidden liked users list and users count, according to the exemplary embodiment of the present invention;

FIG. 8 illustrates the image depicting the hidden liked users list and users count not shown to other users, according to the exemplary embodiment of the present invention;

FIG. 9 illustrates the flow chart depicting of hardware involved, according to the exemplary embodiment of the present invention.

FIG. 10 illustrates the image depicting the differentiation of users open likes and hidden likes, according to the exemplary embodiment of the present invention.

FIG. 11 illustrates the image depicting the favoriting options of the user picture, according to the exemplary embodiment of the present invention;

FIG. 12 illustrates the image depicting giving a custom name to the favorite of user picture, according to the exemplary embodiment of the present invention;

FIG. 13 illustrates the image depicting the open favorite of the user picture, according to the exemplary embodiment of the present invention;

FIG. 14 illustrates the image depicting the hidden favorite of the user picture, according to the exemplary embodiment of the present invention;

FIG. 15 illustrates the image depicting the open favorited users list and users count according to the exemplary embodiment of the present invention;

FIG. 16 illustrates the image depicting the hidden favorited users list and users count, according to the exemplary embodiment of the present invention;

FIG. 17 illustrates the image depicting the hidden favorited users list and users count not shown to other users, according to the exemplary embodiment of the present invention;

FIG. 18 illustrates the image depicting the differentiation of users open favorites and hidden favorites, according to the exemplary embodiment of the present invention.

### DETAILED DESCRIPTION OF THE INVENTION

It is to be understood that the present disclosure is not limited in its application to the details of construction and the arrangement of components set forth in the following description or illustrated in the drawings. The present disclosure is capable of other embodiments and of being practiced or of being carried out in various ways. In addition, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another.

According to an exemplary embodiment of the present invention, a computer implemented system configured to operate user-generated features of content on a social media platform is disclosed. The system comprises a web server, a database, a network interface and a processor.

The web server to access data like personal details, posts, likes, favorites followers and following. The database stores all the data containing in the platform. The network interface configured to receive a network communication sent by a generating user of the broadcast comprising an indication that the user-generated features of content have been uploaded.

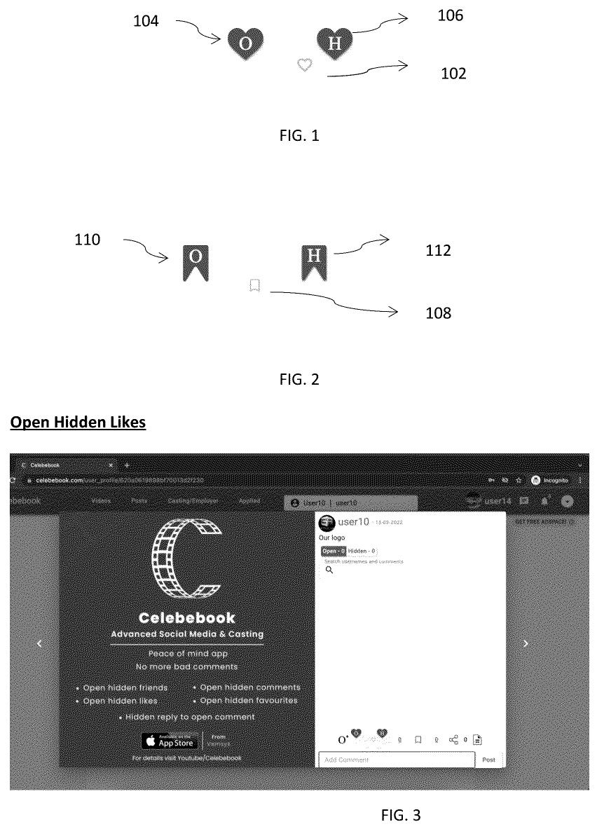

Now referring to the figures, FIG. 1 illustrates the images depicting the open or hidden like buttons of the user picture, in accordance with the exemplary embodiment of the present invention. FIG. 2 illustrates the images depicting the open or hidden favorite buttons, in accordance with the exemplary embodiment of the present invention. FIG. 3 illustrates the image depicting the liking options of the user generated picture, in accordance with the exemplary embodiment of the present invention.

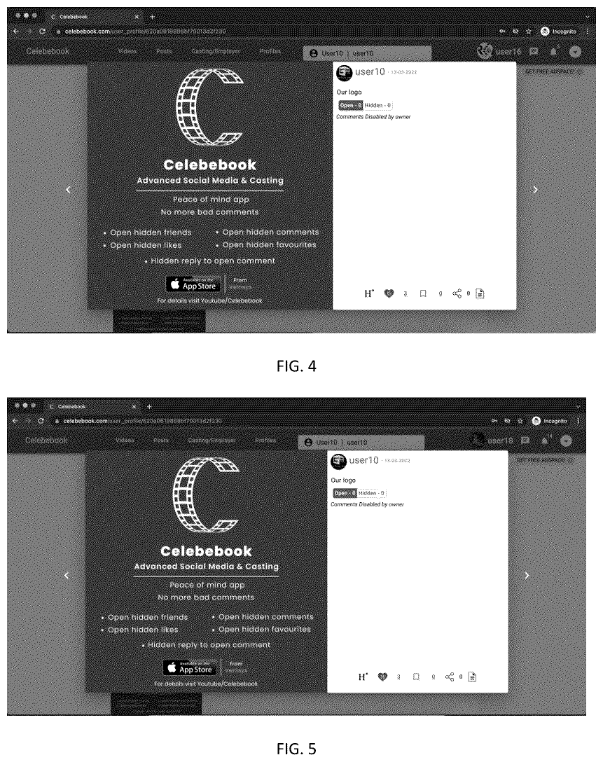

Referring FIGS. 4-5, FIG. 4 illustrates the image depicting the open like of the user picture, in accordance with the exemplary embodiment of the present invention. FIG. 5 illustrates the image depicting the hidden like of the user picture, in accordance with the exemplary embodiment of the present invention.

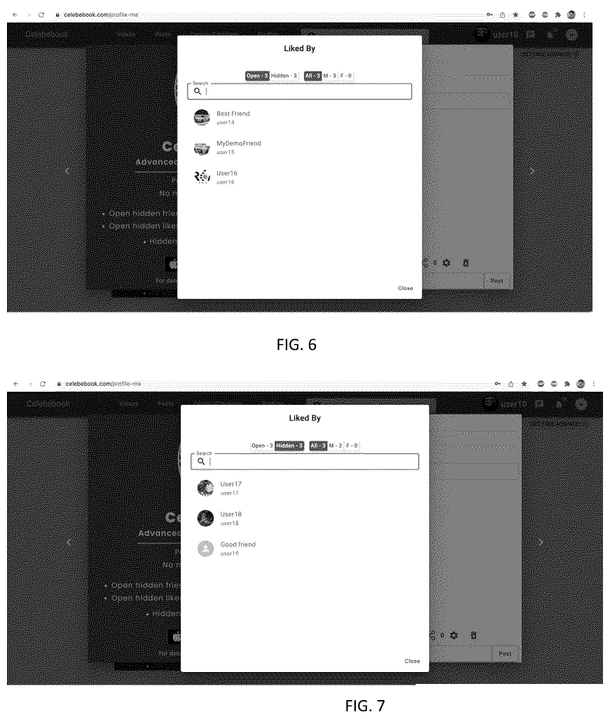

Referring FIGS. 6-7, FIG. 6 illustrates the image depicting the open like gallery of open likes count, in accordance with the exemplary embodiment of the present invention. FIG. 7 illustrates the image depicting the hidden like gallery of hidden likes count, in accordance with the exemplary embodiment of the present invention.

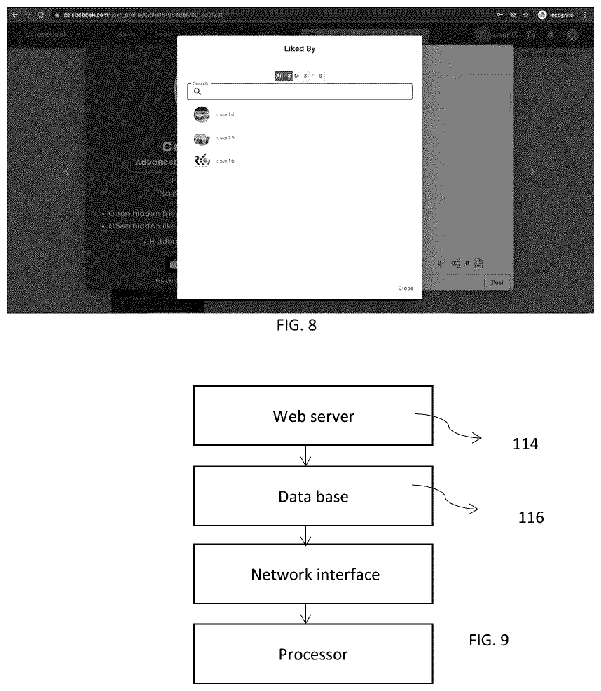

Referring to FIG. 8, it illustrates the image depicting the hidden like gallery of hidden likes count not shown to other users. In accordance with the exemplary embodiment of the present invention.

Referring to FIG. 9, it illustrates the flow chart depicting of hard ware involved in the system, In accordance with the exemplary embodiment of the present invention.

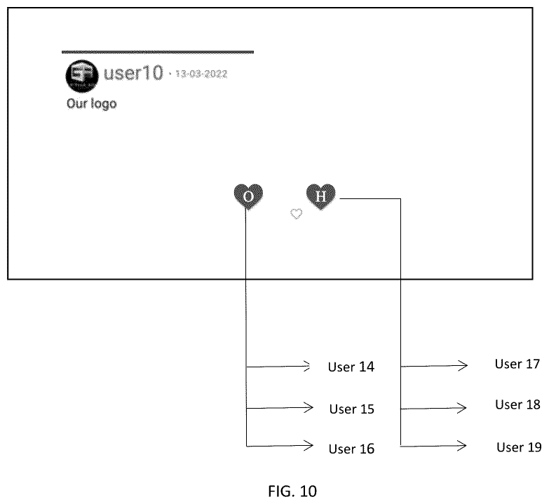

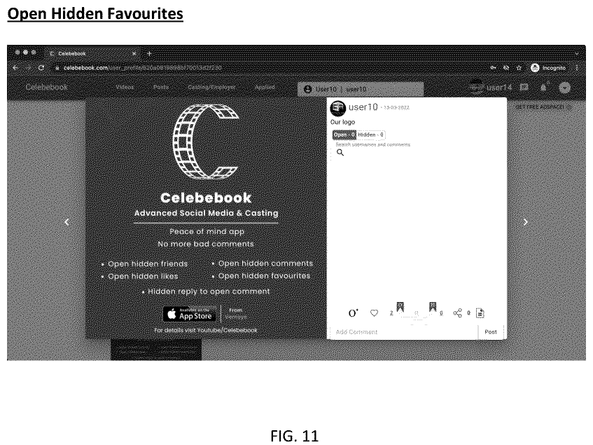

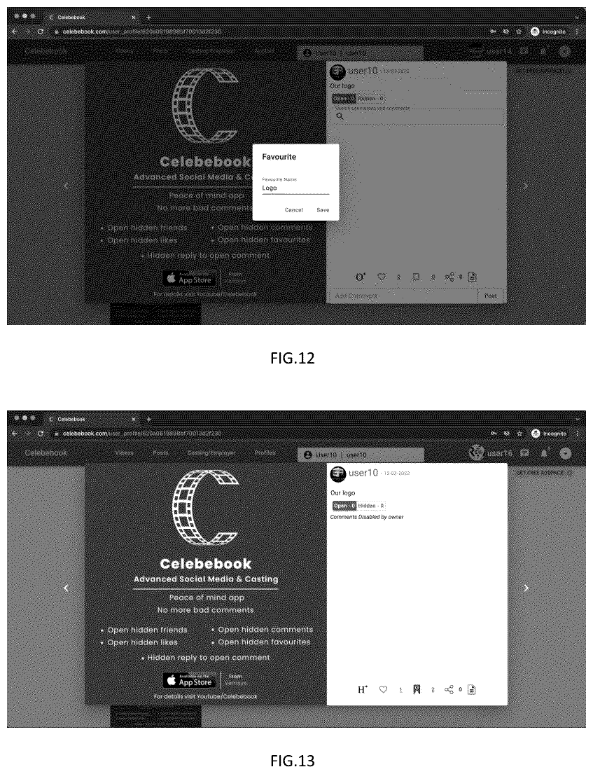

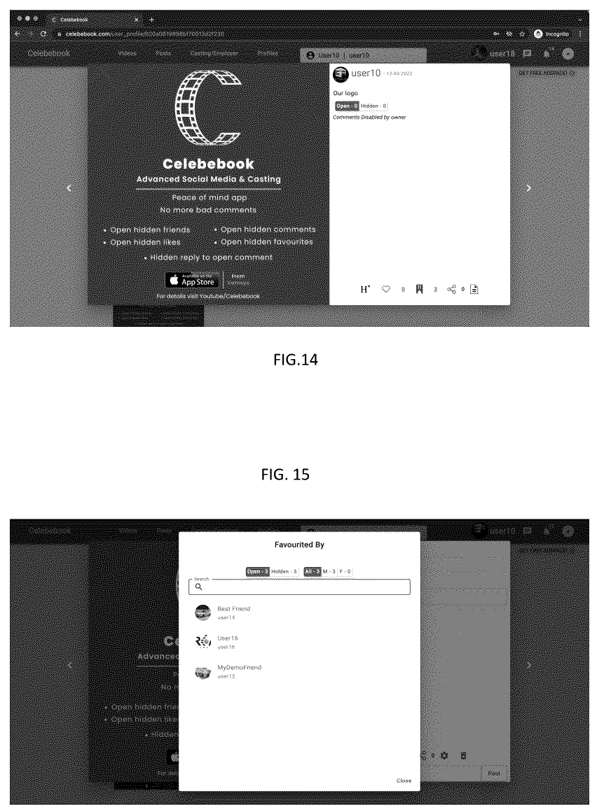

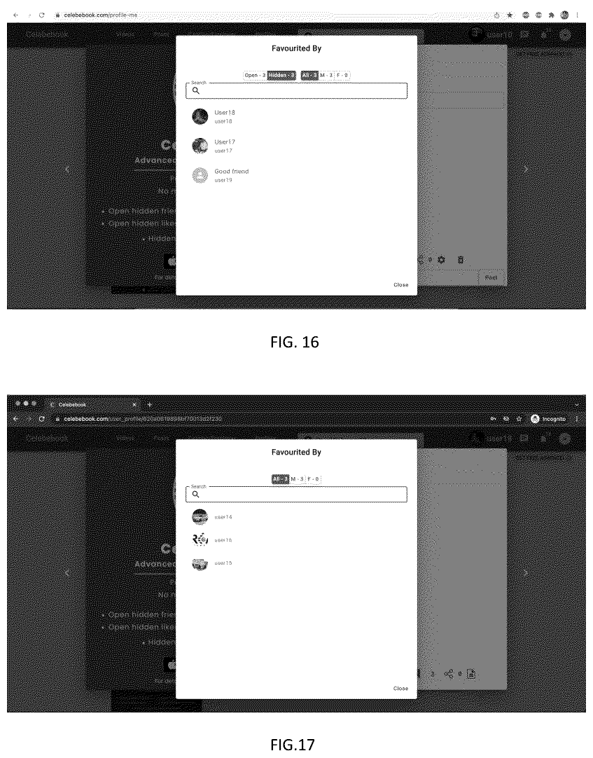

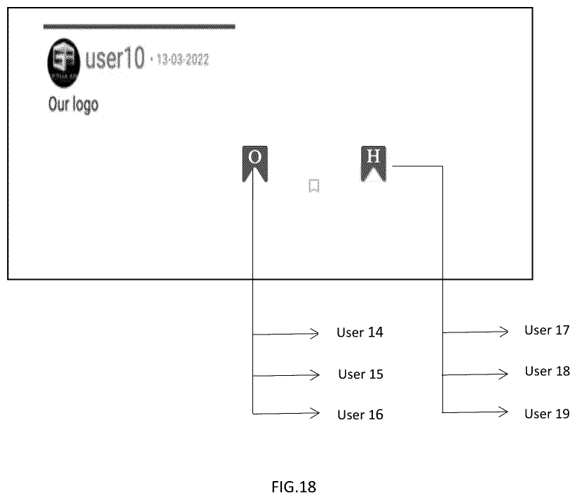

Referring to FIG. 10, it illustrates the image depicting the differentiation of users opting to open likes and hidden likes for user generated content, In accordance with the exemplary embodiment of the present invention.

The said processor coupled to the network interface is configured to open and/or hidden like, and open and/or hidden favorites buttons to be displayed along with the user-generated content to others to choose. The system displays an open like and an open favorite to others on the user-generated content wherein the system never displays an open like and an open favorite to others on the user-generated content.

The system securely operates the features open or the hidden like, and the open or the hidden favorite. The system comprises a rules engine coupled with the network interface and the processor, configured to determine rules for using open/hidden like and favorites on the user-generated content.

The processor is further configured to generate metadata indicating a change in one or both of user-generated items of content expected to be included in a broadcast, and the manner in which the user-generated item of content is to be included in the broadcast.

The user-generated content comprises pictures, audio, video and other files categorized and grouped. The user generated content is provided a time prior to an anticipated time at which it is expected to be included in the broadcast.

The system divides the gallery into open gallery and hidden gallery, open favorites and hidden favorites. The system issues the options of open like or hidden like, and open favorite or hidden favorite to designated users determined by the user generating the content to expose in public or never to expose.

I claim:

1. A computer implemented system, configured to operate user-generated features of content on a social media platform, wherein the system comprises:
a web server to access data like personal details, posts, likes, favorites, followers and following;
a database to store all the data containing in the platform;
a network interface configured to receive a network communication sent by a generating user of the broadcast comprising an indication that the user-generated features of content has been uploaded;
a processor coupled to the network interface and configured to:
open and/or hidden like, and open and/or hidden favorites buttons to be displayed along with the user-generated content to others to choose;
display an open like and an open favorite to others on the user-generated content;
not to display a hidden like and a hidden favorite to others on the user-generated content; and
securely operate the features open or the hidden like, and the open or the hidden favorite.

2. The system as claimed in claim 1, wherein the system comprises a rules engine coupled with the network interface and the processor, and configured to determine rules for using open/hidden like and favorites on the user-generated content.

3. The system as claimed in claim 1, wherein the processor is further configured to generate metadata indicating a change in one or both of user-generated items of content expected to be included in a broadcast, and the manner in which the user-generated item of content is to be included in the broadcast.

4. The system as claimed in claim 1, wherein the user-generated content comprise pictures, audio, video and other files categorized and grouped.

5. The system as claimed in claim 1, wherein the user-generated content is provided at a time prior to an anticipated time at which it is expected to be included in the broadcast.

6. The system as claimed in claim 1, wherein the system divides the gallery into open gallery and hidden gallery, open favorites and hidden favorites.

7. The system as claimed in claim 1, wherein the system issues the options of open like or hidden like, and open favorite or hidden favorite to designated users determined by the user generating the content.

8. The system as claimed in claim 1, when other users see an user profile, open liked gallery visible, hidden liked gallery not shown.

9. The system as claimed in claim 1, when other users see an user profile, open favorited gallery visible, hidden favorited gallery not shown.

10. A method of operating the features open and/or hidden likes, and favorites on social media platform, wherein the method follows:
accessing the system with login credentials;
providing a like for the posting on the platform involves in selecting the options of open like/hidden like;
providing favorite for the posting on the platform involves in selecting the options of open favorite/hidden favorite; and
providing different galleries for different types of likes and favorites.
